(19) United States
(12) Patent Application Publication
(10) Pub. No.: US 2018/0217474 A1
(43) Pub. Date: Aug. 2, 2018

(54) SCATTERED LIGHT TRAP FOR A CAMERA OF A MOBILE UNIT

(71) Applicant: Robert Bosch GmbH, Stuttgart (DE)

(72) Inventor: Ahmad Faridian, Weil der Stadt (DE)

(21) Appl. No.: 15/747,248

(22) PCT Filed: Jun. 24, 2016
(86) PCT No.: PCT/EP2016/064688

§ 371 Date: Jan. 24, 2018

(30) Foreign Application Priority Data
Jul. 27, 2015 (DE) 10 2015 214 189.6

(51) Int. Cl. G03B 11/04; G03B 17/56

(52) U.S. Cl. CPC G03B 11/048; G03B 17/56

(57) ABSTRACT

A scattered light trap for a camera of a mobile unit includes a scattered-light-reducing structure that has rising plane surfaces and falling surfaces that repeat alternatingly in a direction of a light beam incident on the camera, the angles between the rising plane surfaces and a plane of motion of the mobile unit differing at least partially or corresponding to the largest possible angle as a function of specified criteria.

### CROSS-REFERENCE TO RELATED APPLICATIONS

The present application is the national stage of International Pat. App. No. PCT/EP2016/064688 filed Jun. 24, 2016, and claims priority under 35 U.S.C. § 119 to DE 10 2015 214 189.6, filed in the Federal Republic of Germany on Jul. 27, 2015, the content of each of which are incorporated herein by reference in their entireties.

### FIELD OF THE INVENTION

The present invention relates to a scattered light trap for a camera of a mobile unit, the scattered light trap including a scattered-light reducing structure, which has rising plane surfaces and falling surfaces that repeat alternatingly in the direction of the light beam incident on the camera.

### BACKGROUND

DE 10 2004 058 683 A1 describes a scattered light diaphragm for reducing the amount of scattered light striking a camera; in each instance, the scattered light diaphragm being made up of a primary structure and additively including a secondary structure. The primary structures described are characterized by, inter alia, planar surfaces and so-called end faces, which repeat in an alternating manner. In this case, the planar surfaces run at an angle of inclination a, which is other than 0; that is, with respect to the edges of the individual steps, the planar surfaces are sloped either upwards or downwards. Regarding the end faces of the individual steps, these are oriented at an angle of inclination 13, which is not equal to 90°. This means that the end faces of the individual steps are formed to run in an angular range of 80° to 110° with respect to the vertical.

### SUMMARY

The present invention is directed to a scattered light trap for a camera of a mobile unit, the scattered light trap possessing a scattered-light reducing structure, which has rising plane surfaces and falling surfaces that repeat alternatingly in the direction of the light beam incident on the camera.

A feature of the present invention is that the angles between the rising plane surfaces and the plane of motion of the mobile unit differ at least partially or correspond to the largest possible angle, as a function of specified parameters.

The mobile unit can be, for example, a manned vehicle, such as four-wheeled and two-wheeled motor vehicles, ships, or vehicles capable of flying. However, it can also include unmanned vehicles, such as drones.

The plane of motion of the mobile unit is the plane in which the mobile unit is situated at any time; that is, the plane moves and rotates along with the vehicle. If the mobile unit is, for example, a four-wheeled motor vehicle, then the plane of motion of the mobile unit would be, for example, a plane parallel to the four wheels of the motor vehicle.

The largest possible angle is exactly the angle that is to be present between the rising plane surfaces and the plane of motion for the scattered-light-reducing structure to fulfill its task, which is to reduce the amount of scattered light as much as possible.

The present invention has an advantage that due to the shape of the scattered-light-reducing structure of the scattered light trap according to the present invention, no reflected light beams or scarcely any reflected light beams are able to strike the objective of the camera. Since this effect is achieved by the geometric structure, that is, the geometric construction of the scattered-light-reducing structure, the material of which the scattered light trap is made does not make a difference. Therefore, inexpensive materials can also be used for manufacturing such a scattered light trap. In addition, due to the geometric shape of the scattered light trap, the different wave lengths of the incident light do not make a difference, as well. Above all, this advantage becomes apparent in that the scattered light trap also functions for, e.g., infrared light and filters out scattered light in such a manner, that it does not strike the objective of the camera. This replaces the use of absorbing materials, which, along the lines of a scattered light trap, often only function for light of a particular wavelength and are also more expensive. Due to the possible adaptation of the scattered light trap, that is, the adaptation of the scattered-light-reducing structure of the trap to, for example, parameters of the camera and/or of the mobile unit, the scattered light trap can be used in a large variety of ways, that is, with just about any possible camera of nearly any possible mobile unit.

In a particularly preferred, example embodiment, the angles between the rising plane surfaces and the plane of motion of the mobile unit differ at least partially or correspond to the largest possible angle, as a function of at least one specified structural parameter, and/or as a function of at least one specified, characterizing parameter of the mobile unit, in particular, with respect to the type of construction of the mobile unit, and/or as a function of at least one specified camera parameter.

The angles between the rising plane surfaces and the plane of motion of the mobile unit are preferably a function of at least one specified structural parameter. In this context, this structural parameter is a function of a position of the rising surfaces relative to the structure of the scattered light trap and/or relative to the mobile unit, and/or a function of the variation of the rising surfaces of the structure relative to the camera and/or to the mobile unit. The angles between the rising plane surfaces and the plane of motion of the mobile unit differ at least partially or correspond to the largest possible angle.

Preferably, the angles between the rising plane surfaces and the plane of motion of the mobile unit differ at least partially or correspond to the largest possible angle, as a function of at least one specified, characterizing parameter of the mobile unit, which is a function of the angle of inclination of the windshield of the mobile unit.

Preferably, the angles between the rising plane surfaces and the plane of motion of the mobile unit differ at least partially or correspond to the largest possible angle, as a function of at least one specified camera parameter, which is a function of the field of view of the camera.

In a particularly preferred, example embodiment, in the direction of the objective of the camera, the angles between the rising plane surfaces and the plane of motion of the mobile unit increase at least partially or correspond to the largest possible angle determined according to specified criteria, as a function of the distance between the specific, rising surface and the objective of the camera.

In the direction of the objective of the camera, the extension of the rising surfaces preferably decreases at least partially or corresponds to the smallest possible extension determined according to specified criteria, as a function of the distance of the specific, rising surface to the objective of the camera.

The falling surfaces of the scattered light trap preferably have a concave, convex, or undulating shape.

The falling surfaces of the scattered light trap preferably have a concave or convex shape, the curvatures of the falling surfaces being a function of specified radii of curvature.

The falling surfaces of the scattered light trap preferably have a concave or convex shape, the curvatures of the falling surfaces being a function of specified radii of curvature, and the radii of curvature differing at least partially.

Exemplary embodiments of the present invention are explained in greater detail in the following description with reference to illustrations in the drawings.

### BRIEF DESCRIPTION OF THE DRAWINGS

FIG. 1 shows a scattered light trap beneath a windshield of a mobile unit, according to an example embodiment of the present invention.

FIG. 2 shows the scattered light trap with a scattered-light-reducing structure, according to an example embodiment of the present invention.

FIG. 3 shows a detail of the scattered-light-reducing structure, including details of an exemplary set-up of rising plane surfaces and falling surfaces, according to an example embodiment of the present invention.

### DETAILED DESCRIPTION

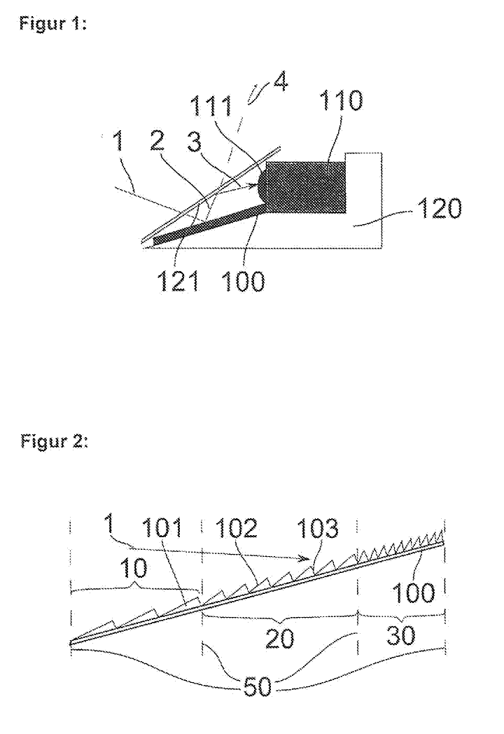

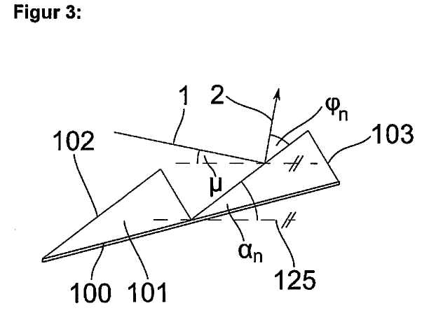

The following explanations and remarks about FIGS. 1, 2 and 3 show, purely by way of example, a method of functioning of a scattered light trap 100 in light of a selected, exemplary set-up (FIG. 1) and of a purely illustrative specific embodiment (FIG. 2), which is explained in more detail, but in an illustrative manner (FIG. 3).

In FIG. 1, scattered light trap 100 is shown beneath windshield 121 of a mobile unit 120, without details about its structure 101.

Mobile unit 120 can be, for example, a manned vehicle, such as four-wheeled and two-wheeled motor vehicles, ships, or also vehicles capable of flying, or can be an unmanned vehicle, such as a drone.

In this case, windshield 121 of mobile unit 120 constitutes a reflective object, which is intended to advantageously illustrate the options for refining the scattered light trap 100, including its scattered-light-reducing structure 101. In this context, of course, other reflective objects and, consequently, other layout options of scattered light trap 100 are also conceivable.

The scattered light trap is mounted below objective 111, in front of a camera 110. A method of functioning of the scattered light trap shall be outlined in light of an incident light beam 1 and its further path 2, 3, 4. Without scattered-light-reducing structure 101, incident light beam 1 is reflected and subsequently strikes windshield 121 of mobile unit 120 again. In this case, a portion of light beam 3 is reflected again and strikes objective 111 of camera 110. The other portion of light beam 4 passes through the windshield and therefore no longer strikes objective 111 of camera 110.

The path of the light beam 1, 2, 3, which strikes objective 111, thus, without the portion of light beam 4, which passes through windshield 121 of mobile unit 120 again, now ensures a flawed and/or inaccurate or blurred recording of camera 110, since reflected light beam 3, which first strikes objective 111 of camera 110 after being reflected, can supply an incorrect depiction of the surroundings of mobile unit 120, and/or can result in overexposure and, therefore, an unusable recording. By installing a scattered light trap 100 having a scattered-light-reducing structure 101, reflected light beam 3 can now be diverted in such a manner that it does not enter the field of view of camera 110.

A possible specific example embodiment of scattered-light-reducing structure 101 of scattered light trap 100 is shown in FIG. 2. In this context, structure 101 is made up of rising plane surfaces 102 and falling surfaces 103 that repeat in an alternating manner.

Rising plane surfaces 102 differ from falling surfaces 103 in that the falling surfaces can also have a concave, convex, or undulating shape. In the example embodiment shown in FIG. 2, the falling surfaces are exclusively plane surfaces.

In this exemplary embodiment, the structure is made up of three different regions 10, 20, 30, in which the density of rising plane surfaces 102 and of falling surfaces 103 is constant within the respective region, but is different, in each case, in comparison with the other regions. This density increases in the direction of incident light beam 1 towards camera 110. In this context, the extension of rising plane surfaces 102 decreases, and the slope of rising plane surfaces 102 increases in the same direction, in comparison with preceding regions. To be more precise, rising plane surfaces 102 of the middle region 20 shown here have a slope greater than the slope of rising plane surfaces 102 of preceding region 10. In exchange, the extension of rising plane surfaces 102 decreases.

In another specific embodiment, all of rising plane surfaces 102 can also have the same slope and/or the same extension in the direction of incident light beam 1. The relevant details, that is, how the slope is to be selected, and of what the slope is a function, are clarified in the explanations regarding FIG. 3.

A detail of scattered light trap 100, including its scattered-light-reducing structure, is depicted in FIG. 3. In this context, it can be, for example, one of the three indicated regions 10, 20, 30 from FIG. 2. Here, the region is generally referred to as the nth region, and the angles between rising plane surfaces 102 and plane of motion 125 of mobile unit 120 (that is, the angle between rising plane surfaces 102 and each plane parallel to plane of motion 125 of mobile unit 120) within the nth region are referred to as αₙ.

This means that there can be any number of regions before the nth region, thus, regions 1 through n−1, and any number after it, including the indices n+1, as well as all subsequent indices. In this context, it is crucial that in each instance, angles αₙ are greater than or equal to angles α₁ through αₙ₋₁ for all possible indices n, and that in each instance, angles αₙ are less than or equal to angles αₙ₊₁ through α_{N} for all possible indices n; in this case, index N determining the number of all regions. Therefore, there is a maximum angle αₘₐₓ and a minimum angle αₘᵢₙ, these being able to be of equal size, thus, αₙ=αₘᵢₙ=αₘₐₓ for all indices n, where 1≤n≤N.

In the same way, for each region n, where 1≤n≤N, there is an angle of reflection φₙ, which describes the angle between reflected light beam 2 and plane of motion 125.

A further quantity for defining angle αₙ between rising plane surfaces 102 and plane of motion 125 of mobile unit 120 is angle of incidence μ between incident light beam 1 and plane of motion 125 of the mobile unit.

In an example embodiment, the following applies for the angles:

∝ₘₐₓ=[φₘₐₓ−μ]/2

as a relation between maximum angle αₘₐₓ, as was described above, and maximum angle of reflection φₘₐₓ between reflected light beam 2 and rising plane surfaces 102. Angle φₘₐₓ can be determined, in turn, as a function of the position and set-up of camera 110 relative to windshield 121 of mobile unit 120 or to other reference points in other exemplary embodiments, in such a manner, that no more reflected light beams 3 enter the field of view of camera 110. Subsequently, all further angles αₙ are defined according to the criteria specified above, in such a manner, that each angle αₙ between rising plane surfaces 102 and plane of motion 125 of mobile unit 120 in the nth region is less than or equal to the corresponding angle in the subsequent region and greater than or equal to the corresponding angle in the preceding region.

Of course, further exemplary embodiments and combined forms of the depicted examples are possible.

1-10. (canceled)

11. A scattered light trap for a camera of a mobile unit, the scattered light trap comprising:
a scattered-light-reducing structure that includes rising plane surfaces and falling surfaces that repeat alternatingly in a direction of a light beam incident on the camera, wherein, as a function of specified parameters, angles between the rising plane surfaces and a plane of motion of the mobile unit differ at least partially or correspond to a largest possible angle.

12. The scattered light trap of claim 11, wherein the specified parameters include at least one of:
at least one specified structural parameter;
at least one specified camera parameter; and
at least one specified characterizing parameter of the mobile unit.

13. The scattered light trap of claim 12, wherein, in a direction of an objective of the camera, the angles between the rising plane surfaces and the plane of motion of the mobile unit increase at least partially or correspond to the largest possible angle, determined according to specified criteria as a function of a distance between the respective, rising plane surfaces and the objective of the camera.

14. The scattered light trap of claim 12, wherein, in a direction of an objective of the camera, an extension of the rising plane surfaces decreases at least partially or corresponds to a smallest possible extension determined according to specified criteria as a function of a distance of the respective, rising surface to the objective.

15. The scattered light trap of claim 11, wherein the specified parameters include at least one specified characterizing parameter of the mobile unit with respect to a type of construction of the mobile unit.

16. The scattered light trap of claim 11, wherein the specified parameters include at least one specified structural parameter that is a function of at least one of:
a position of the rising surfaces relative to the scattered-light-reducing structure;
a position of the rising surfaces relative to the mobile unit;
a variation of the rising surfaces of the structure relative to the camera; and
a variation of the rising surfaces of the structure relative to the mobile unit.

17. The scattered light trap of claim 11, wherein the specified parameters include at least one specified characterizing parameter of the mobile unit that is a function of an angle of inclination of the windshield of the mobile unit.

18. The scattered light trap of claim 11, wherein the specified parameters include at least one specified camera parameter that is a function of the field of view of the camera.

19. The scattered light trap of claim 11, wherein the falling surfaces have a shape that is concave, convex, or undulating.

20. The scattered light trap of claim 11, wherein the falling surfaces have a concave or convex shape, curvatures of the falling surfaces being a function of specified radii of curvature.

21. The scattered light trap of claim 11, wherein the falling surfaces have a concave or convex shape, curvatures of the falling surfaces being a function of specified at radii of curvature that at least partially differ from each other.
